(19) United States
(12) Patent Application Publication
(10) Pub. No.: US 2003/0084793 A1
(43) Pub. Date: May 8, 2003

(54) Press feed mounting system

(76) Inventors: Daniel A. Schoch, Minster, OH (US); Joseph Hamberg, New Bremen, OH (US)

Correspondence Address: RANDALL J. KNUTH P.C., 3510-A STELLHORN ROAD, FORT WAYNE, IN, 46815-4631, US

(21) Appl. No.: 10/263,866

(22) Filed: Oct. 3, 2002

Related U.S. Application Data
(60) Provisional application No. 60/327,343, filed on Oct. 5, 2001.

(51) Int. Cl. B30B 1/00

(52) U.S. Cl. 100/144

(57) ABSTRACT

A press feed mounting system for mounting a press feed having a feed direction to a press includes a base member rigidly connected to the press for supporting the press feed, a shock isolation mounting located between the press feed and the base member, and a press feed link connected between the press feed and the press parallel to the feed direction.

This application relates to and claims the benefit under 35 U.S.C. §119 of Provisional Application Serial No. 60/327,343 filed Oct. 5, 2001 by the same inventor.

### BACKGROUND OF THE INVENTION

1. Field of the Invention

The present invention relates to an improved means for supporting material feeders, such as press feeds, whereby high frequency stamping vibration forces transmitted to the press feed are reduced.

2. Description of the Related Art

It is known that a material feeder, such as a press feed unit may be attached directly to the mechanical press or other machinery. Generally, such feed units for feeding stock materials to the relevant metal forming machines, such as presses, are subject to non-isolated transmission of vibration forces from the machine or press structure. Such transmission of vibration occurs from the press structure, for example, through the attachment brackets to the feed equipment. Also, general cantilevered designs magnify this effect.

In order to prevent the magnification of vibration while press or machine is running, it is essential that the natural frequency of vibration be less than the frequency of vibration corresponding to the material or press feed. Friction or insufficient viscous damping may have been introduced in the past through utilization of a thin, compliant, and elastomeric material attached between brackets and press machine. Unfortunately, this use effects the accuracy of the press feed, since the press feed distance between the press feed and press is apt to change, while the alternative is to stiffen the attachment by torquing or cranking the attachment bolts between the press feed and the press so tight that there is virtually no isolation to vibration transmission.

Historically, cantilever press feed mounting systems have been utilized without sufficient reduction of vibration transmission for extended life times. A new product in the art incorporates with increased frequency the utilizing of electric or servo feed mechanisms for material movement through the press feed to the press. Such electric servo feeds have a low tolerance to vibration levels. Typically, such servo motors cannot handle more than 5 Gs of acceleration. Newer presses, with more aggressive applications, may have the ability to transmit more than the maximum allowable Gs of acceleration to the press feed and servos.

For example, the cantilever mounting of such press feeds or other feed mechanisms may typically amplify the vibration, thereby exceeding the manufacturer's specification of reliability and life of such servo motors. Additionally, the other components mounted to the press feed such as mechanical, hydraulic, or electrical components are all subject to the magnification of the vibration levels. The practices of directly driving the feed rolls, and the use of new, longer width, servo rollers further increase the cantilever magnification effect within the press or material feed unit.

What is needed in the art is an apparatus and method to reduce the relative press to feed axial motion of the press and feed mechanism (and thus material movement accuracy) while still reducing the transmitted vibration from the press to the feed mechanism.

### SUMMARY OF THE INVENTION

According to the present invention an apparatus for supporting a press feed or other material feed unit to a metal forming device is provided, for example, to a mechanical press. The press feed mounting system of the present invention creates rigidity in the direction of the feed travel of the stock material being incrementally moved into the metal working machine. This rigidity thereby maintains the feed accuracy necessary for precise metal forming of press applications. The mounting system additionally creates a soft, compliant, and damping of movement of vibration in a direction vertical and perpendicular to the press feed direction, thereby isolating and dampening transmission of vibration from the metal working machine to the feed unit.

A press or material feed link is connected between the metal forming or press machinery and the feed unit parallel to the direction of the feed direction or material movement. Thereby, this link thus allows small vertical movement perpendicular to the material motion, yet still isolating the vibration transmission. Thereby, feed accuracy is maintained.

The invention, in one form thereof, comprises a press feed mounting system for mounting a press feed having a feed direction to a press. The system includes a base member rigidly connected to the press for supporting the press feed, a shock isolation mounting located between the press feed and base member, and a press feed link connected between the press feed and press, parallel to the feed direction.

The present invention may be utilized for press feeds having a servo motor or press feed drive. Additionally, an elastomeric sheet may optionally be connected between the base member and press to selectively damp high frequency vibrations.

The invention, in another form thereof, comprises a press feed mounting system for mounting a press feed having a feed direction to a press. The system includes a base member connected to the press for supporting the press feed, a compressive or shear type shock isolation mounting system located between the press feed and the base member, and a press feed link connected between the press feed and the base member, parallel to the feed direction.

The invention, in yet another form thereof, comprises a method of reducing force transmitted from the operated mechanical press to the press feed by providing an elastomeric, shear, or compression pad type isolator for supporting the press feed in a vertical direction while creating a rigid attachment in the horizontal direction, parallel to the feed direction of the feed unit, whereby vibration transmission to the press feed is reduced.

An advantage of the present invention is that, by reducing the vibration transmitted to the material or press feed, a longer feed unit operational lifetime is possible.

Another advantage of the present invention is that enhanced servo motor life of the press or material feed unit with reduced G load rating is possible, thereby creating the possibility of utilizing less costly servo motors.

A further advantage of the invention is that a more accurate mounting of the press feed is possible with less vibration transmission, thereby reducing variations in feed length between the feed unit and the metal forming machine.

Yet another advantage of the invention is the press feed mounting system reduces the degrees of freedom of movement of the press feed as compared to prior art feed units.

Another advantage of the invention is that through the use of enhanced linkages and bearings, more accurate feeding of stock material is possible.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a side diagrammatic view of the apparatus of the present invention; and

FIG. 2 is a side diagrammatic view of an alternate body of the present invention.

FIG. 3 is a side diagrammatic view of a third embodiment of the present invention.

FIG. 4 is a side diagrammatic view of a fourth embodiment of the present invention.

Corresponding reference characters indicate corresponding parts throughout the several views. The exemplifications set out herein illustrates at least one preferred embodiment of the invention, in one form, and such exemplifications are not to be construed as limiting the scope of the invention in any manner.

### DETAILED DESCRIPTION OF THE INVENTION

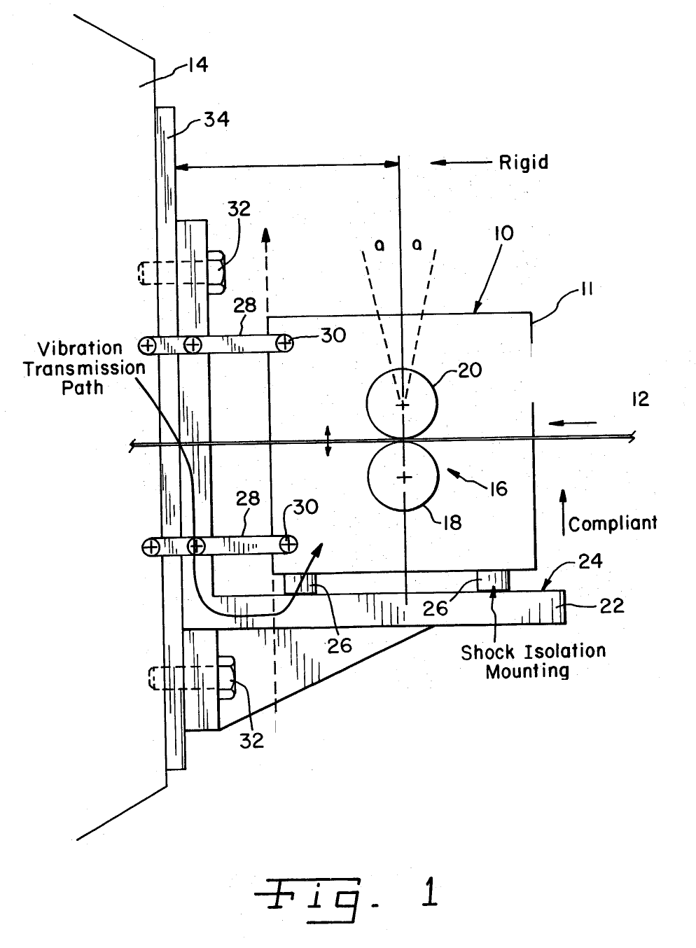

Referring now to the drawings and particularly to FIG. 1, there is shown the press feed mounting system for the present invention. A material feed unit, such as a press feed unit 10, is represented in block form, although press feed units come in various types of shapes and sizes. In some press feeds associated conveyors, chutes, rollers, and other equipment may be included for guiding the feed material 12 running from a source (not shown) to the metal forming machine, for example, press 14.

As shown in FIG. 1, feed material 12 includes a preferred direction of travel caused by the feed unit 10, utilizing in one form, a drive and pinch roller arrangement 16, and in more detail a drive roller 18 in conjunction with pinch roller 20. Together drive roller 18 and pinch roller 20, when activated, move feed material 12 toward the metal forming machine such as press 14 (represented in block form). In a preferred form of the invention, drive roller 18 may be of the servo motor roller type, as conventionally utilized. Drive and pinch roller arrangement 16 is attached for rotation within housing 11 of press feed unit 10.

A base member 22 is rigidly connected to the press for supporting press feed unit 10. In FIG. 1, base member 22 is shown as an L-shaped member having a platform surface 24 on which shock isolation mounts 26 are located. Shock isolation mounts 26 are located between press feed 10 and base member 22 and permit compliance or isolation of the vibration transmission path from the press 14 to press feed unit 10.

Various forms of shock isolation mounts 26 may be utilize such as elastomeric isolators made from a number of different semi-solid materials such a urethane, rubber, and other materials having a natural resinated frequency much lower than the frequencies of forces to be damped from press 14 to press feed unit 10. Furthermore, compression pad type and/or shear pad type isolators may be utilized. Shock isolation mounts 26 permit, but reduce, acceleration transmission through base member 22 into press feed housing 11.

The present invention further includes the use of press feed attachment links 28 connected between the press feed unit 10 and either base member 22 and/or to press 14. Press feed attachment links 28 provide a rigid linkage arrangement in the direction parallel to feed direction of feed material 12. As shown in FIG. 1, a double length arrangement utilizing four (4) press feed attachment links 28 is utilized, only two such links 28 being shown in the side elevational view. Such use of the attachment links eliminate unwanted parallel-to-feed, press/feed motion variations in the change of the size of the particular feed material 12 input to press 14. Press feed attachment links 28 are attached between the press feed unit housing 11 to either base member 22 and/or press 14 via shoulder bolts 30.

In one form of the invention, shoulder bolts 30 could be replaced by pre-loaded type bearings or zero type clearance bearings that allow for free small movement but prevent total free running between the parts. As shown in FIG. 1, base member 22 may be attached with bolts 32 to press 14.

In another embodiment of the invention, as shown in FIG. 1 a small layer of elastomeric material such as a neoprene type of material 34 may be disposed between base member 22 and press 14. Such use is not necessary for the invention, but may assist in tuning the frequency response of the mounting system.

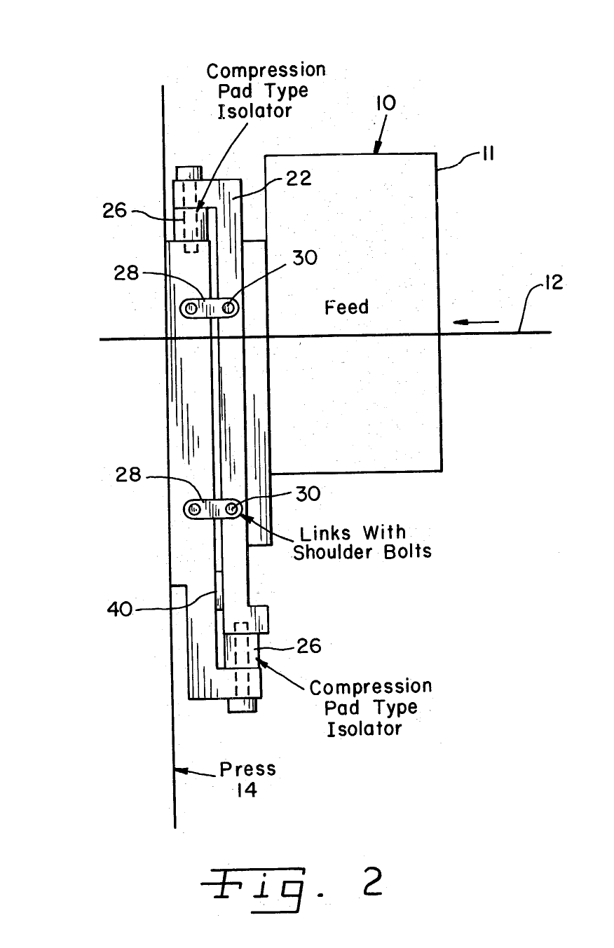

An alternate apparatus for the press feed mounting system of the present invention is shown in FIG. 2, in which press feed unit 10 and housing 11 is connected to base member 22 in a vertical direction by bolts (not shown). Here again, a vibration transmission path is caused to be routed vertically through shock isolation mounts 26, although press feed attachment lengths 28 are still utilized. As can be readily apparent, different geometries may be utilized for the press feed mounting system of the present invention. Each geometry includes the requirement of having rigidity in the direction parallel to the press feed direction while having a resilient or compliant dampening effect possibly created by shock isolation mounts or other means in a direction perpendicular to the press feed or material feed direction.

The present invention, as shown in FIG. 1 or FIG. 2, reduces a maximum vibration transmitted from the metal forming machine or press 14 to feed unit housing 11 to a degree so that the associated parts within the feed unit 10 may have a longer operational life. By changing the vibration and forces transmitted through the elastomeric shock isolation mounts 26 transmitted forces to the feed unit 10 and housing 11 are controlled.

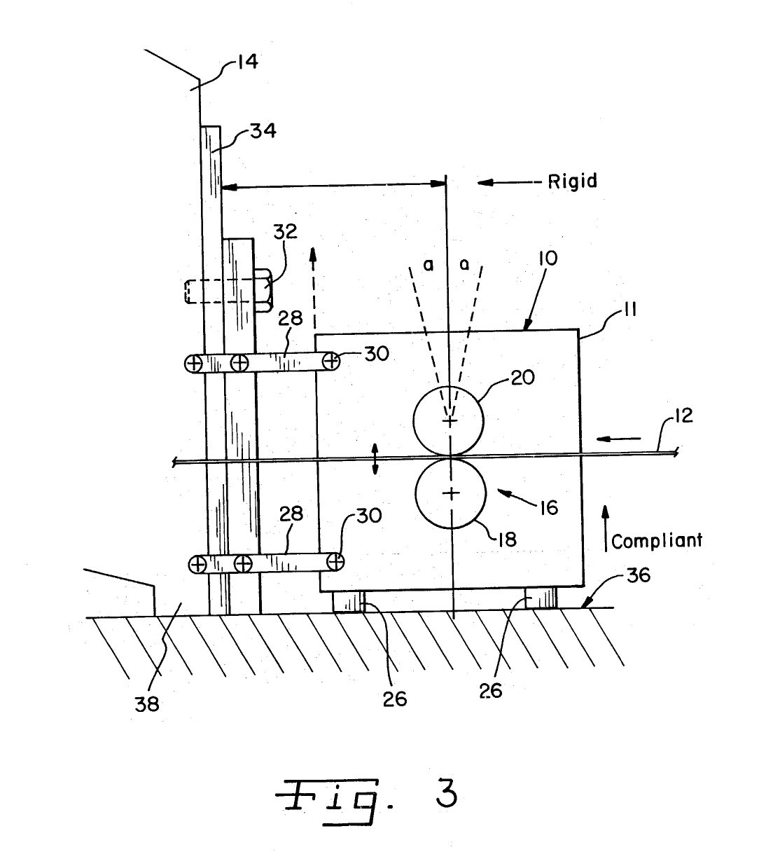

A further embodiment shown in FIG. 3 is similar to that shown in FIG. 1 is except that, instead of being supported from below by base member 22, press feed unit 10 is mounted, via shock isolation mounts 26, on floor or ground 36. Base member 22 still is used to assert the position of press feed unit 10 relative to press 14. Concurrently, press 14 is shown to be supported upon floor/ground 36 via press legs 38 (one of which is illustrated).

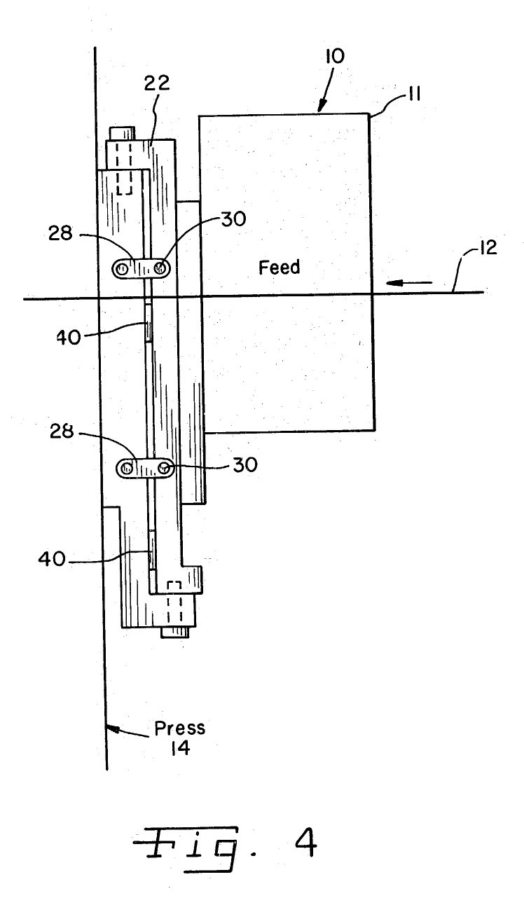

A fourth embodiment is illustrated in FIG. 4. This embodiment is similar to that in FIG. 2 except that shear isolator pads 40 effectively maintain a horizontal spacing between press feed unit 10 and base member 22 and create a vibration transmission path between metal forming machine or press 14 and feed unit 10.

One of the ordinary skill in the art will recognize that various combinations of the embodiments shown in FIGS. 1-4 are possible and may prove advantageous. For example, both compression and shear isolation pads can be employed in a single embodiment to further dampen vibrations.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A press feed mounting system for mounting a press feed having a feed direction to a press, the system comprising:
a base member rigidly connected to the press for positively supporting the press feed;
a shock isolation mounting located between the press feed and said base member; and
a press feed link connected between the press feed and the press parallel to the feed direction.

2. The press feed mounting system of claim 1 further comprising a press feed having a servomotor press feed.

3. The press feed mounting system of claim 1 further comprising an elastomeric sheet connected to said base member, said elastomeric sheet located between said base member and the press.

4. A press feed mounting system for mounting a press feed having a feed direction to press, the system comprising:
a base member rigidly connected to the press for supporting the press feed;
a shock isolation mounting located between the press feed and said base member; and
a press feed link connected between the press feed and said base member parallel to the feed direction.

5. The press feed mounting system of claim 4, further comprising a press feed having a servomotor press feed.

6. The press feed mounting system of claim 4 further comprising an elastomeric sheet connected to said base member, said elastomeric sheet located between said base member and said press.

7. The press feed mounting system of claim 4, wherein said shock isolation mounting is one of a compression isolator pad and a shear isolator pad.

8. The press feed mounting system of claim 7, wherein said shock isolation mounting pad is a compressive isolator pad mounted so as to ensure a vertical spacing between the press feed and said base member.

9. The press feed mounting system of claim 7, wherein said shock isolation mounting pad is a shear isolation pad mounted so as to ensure horizontal spacing between the press feed and said base member.

10. A press feed mounting system for mounting a press feed having a feed direction to a press, the press feed being mounted upon a floor, the system comprising:
a base member rigidly connected to the press for positively positioning the press feed relative thereto;
a shock isolation mounting located between the press feed and the floor; and
a press feed link connected between the press feed and the press parallel to the feed direction.

11. The press feed mounting system of claim 10 further comprising a press feed having a servomotor press feed.

12. The press feed mounting system of claim 10 further comprising an elastomeric sheet connected to said base member, said elastomeric sheet located between said base member and the press.
